(19) United States
(12) Patent Application Publication
(10) Pub. No.: US 2012/0284383 A1
(43) Pub. Date: Nov. 8, 2012

(54) CLOUD WORKLOAD MANAGEMENT WITH AUTOMATED WORKLOAD BIDDING

(75) Inventors: Clark A. Dudek, Raleigh, NC (US); Phillip D. Jones, Raleigh, NC (US); David B. Roberts, Cary, NC (US); Adrian X. Rodriguez, Durham, NC (US); Ian C. Tewksbury, Morrisville, NC (US); Ping Zhou, Poughkeepsie, NY (US)

(73) Assignee: INTERNATIONAL BUSINESS MACHINES CORPORATION, Armonk, NY (US)

(21) Appl. No.: 13/102,538

(22) Filed: May 6, 2011

(51) Int. Cl. G06F 15/173

(52) U.S. Cl. 709/223

(57) ABSTRACT

A computer program product is provided for managing workload in a computer system. Computer usable program code cause a first compute node to broadcast a workload bid request to a plurality of compute nodes, wherein the workload bid request includes workload parameters. The compute nodes each receive the request from the first compute node, and each compute node uses the workload parameters to calculate a cost of running the workload. One or more individual compute nodes within the plurality of compute nodes send a workload bid to the first compute node, wherein each workload bid includes the cost of running the workload on the individual compute node sending the workload bid. The first compute node receives and uses each workload bid to select a target compute node to run the workload, wherein the target compute node is selected from the individual compute nodes and the first compute node.

### BACKGROUND

1. Field of the Invention

The present invention relates to workload management in computer systems.

2. Background of the Related Art

In a cloud computing environment, a management system performs constant monitoring of numerous compute nodes that make up the cloud. Accordingly, the management system may take steps to balance the load among the individual compute nodes, and may deploy workloads to compute nodes that are able to perform appropriately.

In various implementations, the management system is the centralized point for workload distribution and has access to information about the condition of all servers and all workloads. The management system collects this information and uses it to determine how to move and rearrange workloads to accomplish one or more operational objective. The management system, such as a management server, is limited as to what information it can collect about the individual servers or hosts. In some systems, server operating conditions are exposed to the management server so that the management server can make a more informed decision as to which host should receive a given workload. However, as more information is shared with the management system, the management system may require hardware and software upgrades in order to be able to manage the larger infrastructure.

In one system, a server may send a job request to the centralized management system. The management system then uses information about the operating condition of each server to determine which server should receive the workload associated with the job request.

### BRIEF SUMMARY

One embodiment of the present invention provides a computer-implemented method for workload management in a computer system. According to the method, a first compute node broadcasts a workload bid request to a plurality of compute nodes, wherein the workload bid request includes workload parameters characterizing the workload. The plurality of compute nodes each receive the workload bid request from the first compute node, and each of the plurality of compute nodes uses the workload parameters included in the workload bid request to calculate a cost of running the workload. One or more individual compute nodes within the plurality of compute nodes will each send a workload bid to the first compute node, wherein each workload bid includes the cost of running the workload on the individual compute node sending the workload bid. The first compute node receives each workload bid and uses each workload bid to select a target compute node to run the workload, wherein the target compute node is selected from the one or more individual compute nodes and the first compute node.

Another embodiment of the invention provides a computer program product including computer usable program code embodied on a computer usable storage medium for workload management in a computer system. The computer program product comprises computer usable program code for a first compute node broadcasting a workload bid request to a plurality of compute nodes, wherein the workload bid request includes workload parameters characterizing the workload. Computer usable program code is also included for the plurality of compute nodes each receiving the workload bid request from the first compute node, and each of the plurality of compute nodes using the workload parameters included in the workload bid request to calculate a cost of running the workload. Computer usable program code also provides for one or more individual compute nodes within the plurality of compute nodes to each send a workload bid to the first compute node, wherein each workload bid includes the cost of running the workload on the individual compute node sending the workload bid. Computer usable program code also provides for the first compute node receiving each workload bid and using each workload bid to select a target compute node to run the workload, wherein the target compute node is selected from the one or more individual compute nodes and the first compute node.

### BRIEF DESCRIPTION OF THE SEVERAL VIEWS OF THE DRAWINGS

FIG. 1 is a diagram of a cloud computing node according to one or more embodiment of the present invention.

FIG. 2 is a diagram of a cloud computing environment according to one or more embodiment of the present invention.

FIG. 3 is a diagram depicting abstraction model layers according to one or more embodiment of the present invention.

FIG. 4 is a diagram of an exemplary computing node that may be utilized according to one or more embodiments of the present invention.

FIG. 5 is a diagram of an exemplary blade chassis that may be utilized according to one or more embodiments of the present invention.

FIG. 6 is a diagram of a first compute node broadcasting a workload bid request to a group of compute nodes that respond to the first compute node with a workload bid.

FIG. 7 is a diagram of an individual compute node.

FIG. 8 is a flowchart of a method for workload management in a computer system.

### DETAILED DESCRIPTION

One embodiment of the present invention provides a computer-implemented method for workload management in a computer system. According to the method, a first compute node broadcasts a workload bid request to a plurality of compute nodes, wherein the workload bid request includes workload parameters characterizing the workload. The plurality of compute nodes each receive the workload bid request from the first compute node, and each of the plurality of compute nodes uses the workload parameters included in the workload bid request to calculate a cost of running the workload. One or more individual compute nodes within the plurality of compute nodes will each send a workload bid to the first compute node, wherein each workload bid includes the cost of running the workload on the individual compute node sending the workload bid. The first compute node receives each workload bid and uses each workload bid to select a target compute node to run the workload, wherein the target compute node is selected from the one or more individual compute nodes and the first compute node.

The first compute node and the plurality of compute nodes may be in a multi-server chassis, a rack, or the compute nodes may each be standalone compute nodes. Furthermore, the first compute node and the plurality of compute nodes may be in communication over a local area network, wide area network, or some combination of network types.

A workload is a process to be run by a compute node, possibly in response to an action taken by a user or management software. Prior to a workload being executed in the environment, the first compute node generates a workload bid request that includes workload parameters characterizing the workload and sends the workload bid request to all of the other compute nodes. Although the workload bidding process provides the greatest benefit to a compute node that is already operating at a high percentage of processor, memory, or network capacity (i.e., it is resource constrained) at the time it is assigned a further workload, it is preferable for the compute nodes to generate a workload bid request for each new workload. However, a compute node that is not resource constrained is more likely to submit a bid and/or select to run its own workloads. The workload parameters included in the workload bid request may include, for example, memory available, processor speed, network latency, potential workloads in queue, battery life remaining (if applicable), energy cost (for example, per compute cycle, rack level or datacenter level), affinity information, system temperature, location, server type, and bidding window (i.e., time to process). In a further option, the workload bid request may include the workload itself. As any of the compute nodes become resource constrained, they may each generate and broadcast a workload bid request to the other compute nodes. Accordingly, the task of generating and broadcasting workload bid requests is distributed among the compute nodes, as is the task of generating and responding with workload bids.

In one embodiment, the workload bid request may include a cost calculation function that the compute node should use in calculating a cost value for inclusion in its workload bid. For example, the workload bid request may include a function optimized for speed where the cost function parameters include processor speed, network latency, and memory. The workload bid request may also include a function optimized for location (due to regulatory concerns) to include certain regions and exclude others. So, network latency and location parameters will be sent. Finally, a workload bid request might include a function to find the most inexpensive process and so it would include energy cost and temperature. Optionally, the workload bid request may further indicate whether the workload should be optimized for time, energy use or monetary cost (in the case of external third party cloud providers).

The first compute node may broadcast the workload bid request over TCP/IP, bluetooth, or any other communication protocol. The term “broadcast” means that the workload bid request is sent or otherwise made available to any or all compute nodes in a network or communication domain, such as a virtual machine migration domain. The workload bid request is provided to compute nodes throughout a network with the objective of finding a computer node that will respond with a low workload bid (i.e., finding a computer node that has a high availability to run the workload).

The plurality of compute nodes receiving the workload bid request, optionally including a cost function, and may reply with a workload bid. Optionally, if any of the plurality of compute nodes determines that they are resource constrained, then that compute node may not generate or respond with a workload bid. Those of the plurality of compute nodes that are not resource constrained (i.e., have available capacity) at the time will calculate and respond with a workload bid that includes the cost of that compute node running the workload. In a further option, an individual compute node may, after receiving a workload bid request, periodically calculate and respond with a new workload bid to reflect the current resource availability and operating conditions of the individual compute node. Once the first compute node broadcasts an indication that the workload has been awarded to a target compute node, then the individual compute nodes will no longer calculate further workload bids for the given workload.

The first compute node selects a target compute node where the workload will be run on the basis of the workload bids received. The target compute node may be any of the plurality of compute nodes that responded with a workload bid, or it may be the first compute node itself. In one embodiment, the compute node submitting the lowest cost bid will be selected as the target node for that workload. In other embodiments, the target node may be selected on the basis of one or more specific metric, such as energy consumption, network bandwidth, or time needed to complete a transaction. Still further, the first compute node may retain and run a workload for which it sent out a workload bid request, in response to receiving no workload bids from the other compute nodes during a threshold period of time.

Following the selection of a target compute node, the data workload or virtual machine will be assigned and dispatched to the target (destination) compute node. It should be understood that the data workload or virtual machine that needs to be executed is preferably not subdivided, but rather dispatched as a whole to the target compute node.

In a further embodiment, the first compute node will broadcast a message to the plurality of compute nodes indicating that the workload bid request has been awarded. Optionally, this broadcast message may include the cost provided by the workload bid of the target compute node selected to receive the workload. The plurality of compute nodes may track or store this historical winning bid data, perhaps include the workload parameters of the workload bid request, for the purpose of submitting workload bids in response to subsequent workload bid requests.

It should be recognized that embodiments of the invention eliminate the need for a centralized bid controller. Rather, each compute node calculates its own “cost” of running a given workload described in a workload bid request. When a compute node decides to offload a workload to another compute node, it may directly dispatch the workload to the selected compute node. Alternatively, the compute node offloading the workload may identify the selected compute node to a local provisioning manager or a global provisioning manager for the purpose of dispatching the workload to the selected compute node. Even if a provisioning manager is involved, the peer-to-peer bidding avoids placing a heavy load on the management system.

Another embodiment of the invention provides a computer program product including computer usable program code embodied on a computer usable storage medium for workload management in a computer system. The computer program product comprises computer usable program code for a first compute node broadcasting a workload bid request to a plurality of compute nodes, wherein the workload bid request includes workload parameters characterizing the workload. Computer usable program code is also included for the plurality of compute nodes each receiving the workload bid request from the first compute node, and each of the plurality of compute nodes using the workload parameters included in the workload bid request to calculate a cost of running the workload. Computer usable program code also provides for one or more individual compute nodes within the plurality of compute nodes to each send a workload bid to the first compute node, wherein each workload bid includes the cost of running the workload on the individual compute node sending the workload bid. Computer usable program code also provides for the first compute node receiving each workload bid and using each workload bid to select a target compute node to run the workload, wherein the target compute node is selected from the one or more individual compute nodes and the first compute node. Optionally, the computer program product may further include computer usable program code for implementing any one or more of the steps in the computer-implemented methods described herein.

It should be understood that although this disclosure is applicable to cloud computing, implementations of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

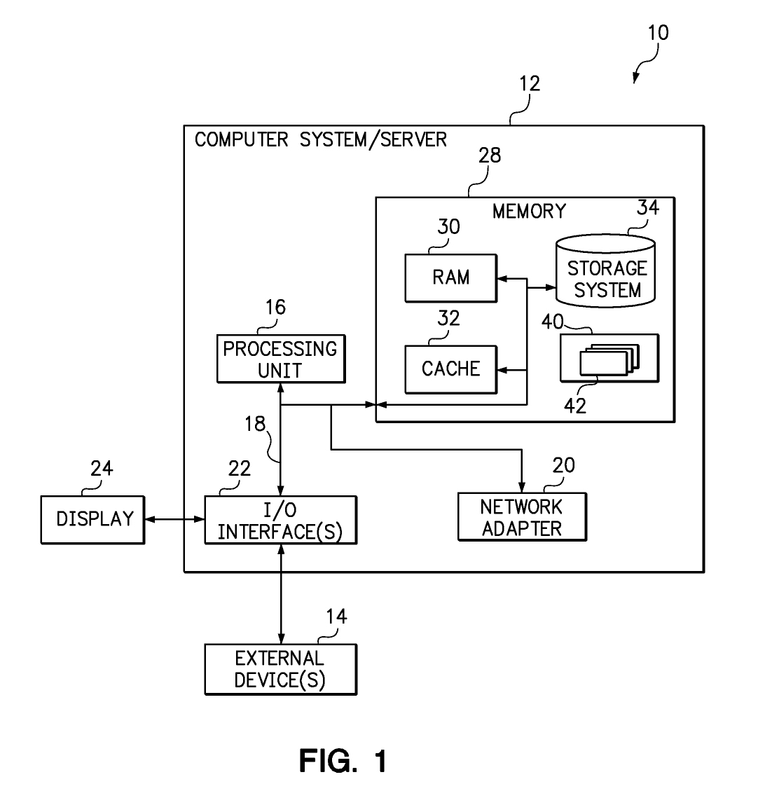

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

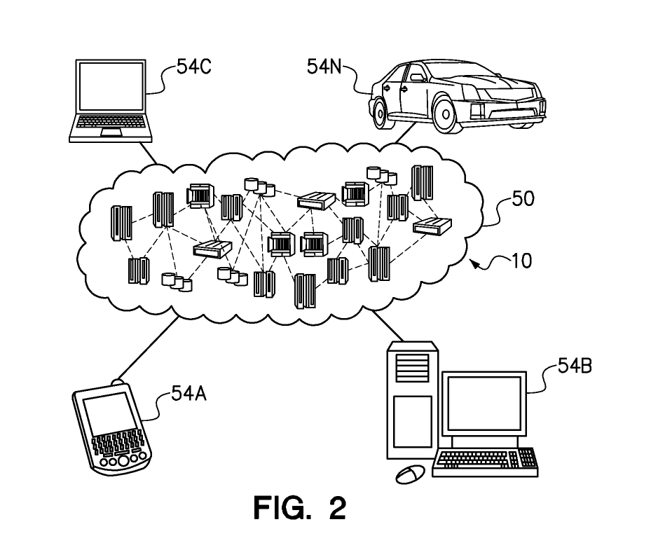

Referring now to FIG. 2, an illustrative cloud computing environment 50 is depicted. As shown, the cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

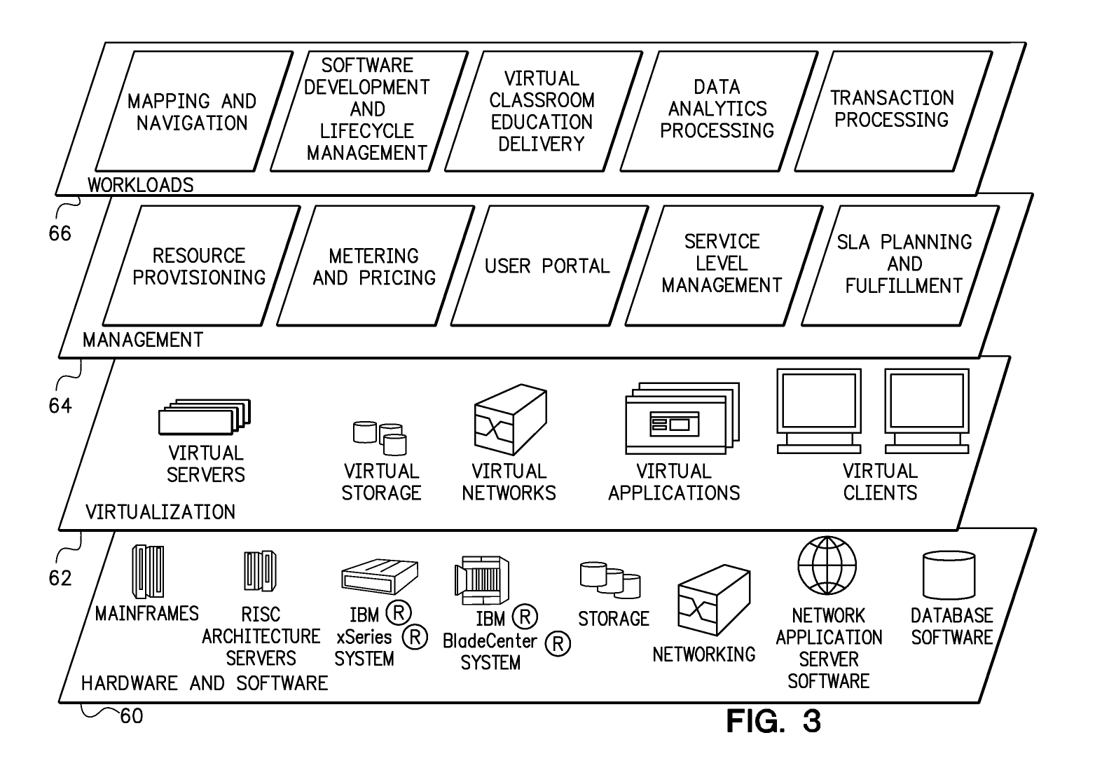

Referring now to FIG. 3, a set of functional abstraction layers provided by cloud computing environment 50 (Shown in FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; and transaction processing.

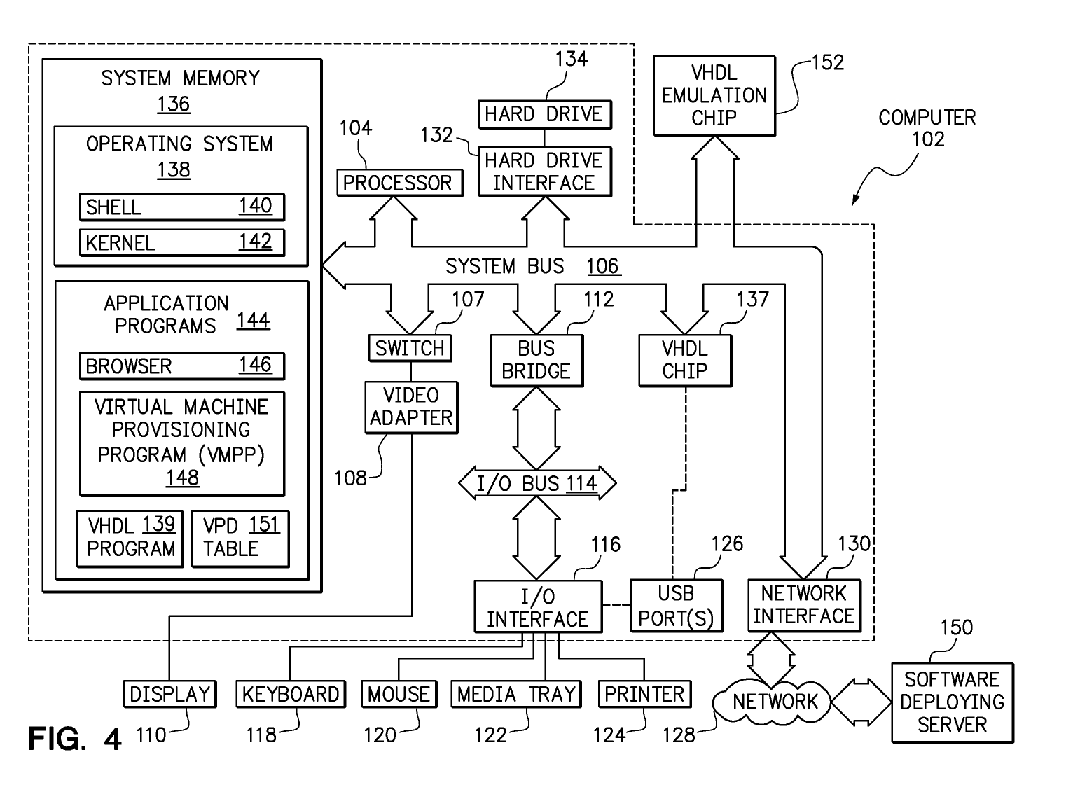

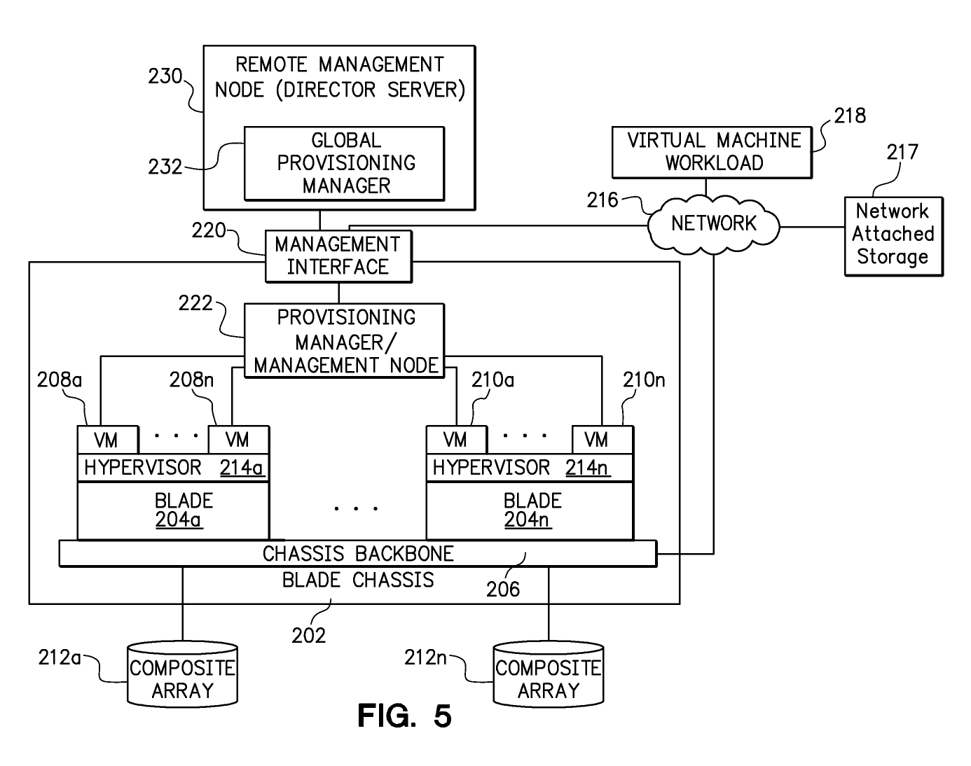

FIG. 4 depicts an exemplary computing node (or simply “computer”) 102 that may be utilized in accordance with one or more embodiments of the present invention. Note that some or all of the exemplary architecture, including both depicted hardware and software, shown for and within computer 102 may be utilized by the software deploying server 150, as well as the provisioning manager/management node 222 and the server blades 204a-n shown in FIG. 5. Note that while the server blades described in the present disclosure are described and depicted in exemplary manner as server blades in a blade chassis, some or all of the computers described herein may be stand-alone computers, servers, or other integrated or stand-alone computing devices. Thus, the terms “blade,” “server blade,” “computer,” and “server” are used interchangeably in the present descriptions.

Computer 102 includes a processor unit 104 that is coupled to a system bus 106. Processor unit 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, preferably mechanical, that allows the display 110 to be coupled to the system bus 106, and thus to be functional only upon execution of instructions (e.g., virtual machine provisioning program—VMPP 148 described below) that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below), external USB port(s) 126. While the format of the ports connected to I/O interface 116 may be any known to those skilled in the art of computer architecture, some or all of these ports may be universal serial bus (USB) ports.

As depicted, computer 102 is able to communicate with a software deploying server 150 via network 128 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

The operating system 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other described computer systems.

Application programs 144 in the system memory of computer 102 (as well as the system memory of the software deploying server 150) also include a virtual machine provisioning program (VMPP) 148. VMPP 148 includes code for implementing the processes described below, including those described in FIGS. 2-8. VMPP 148 is able to communicate with a vital product data (VPD) table 151, which provides required VPD data described below. In one embodiment, the computer 102 is able to download VMPP 148 from software deploying server 150, including in an on-demand basis. Note further that, in one embodiment of the present invention, software deploying server 150 performs all of the functions associated with the present invention (including execution of VMPP 148), thus freeing computer 102 from having to use its own internal computing resources to execute VMPP 148.

Also stored in the system memory 136 is a VHDL (VHSIC hardware description language) program 139. VHDL is an exemplary design-entry language for field programmable gate arrays (FPGAs), application specific integrated circuits (ASICs), and other similar electronic devices. In one embodiment, execution of instructions from VMPP 148 causes the VHDL program 139 to configure the VHDL chip 137, which may be an FPGA, ASIC, or the like.

In another embodiment of the present invention, execution of instructions from VMPP 148 results in a utilization of VHDL program 139 to program a VHDL emulation chip 151. VHDL emulation chip 151 may incorporate a similar architecture as described above for VHDL chip 137. Once VMPP 148 and VHDL program 139 program VHDL emulation chip 151, VHDL emulation chip 151 performs, as hardware, some or all functions described by one or more executions of some or all of the instructions found in VMPP 148. That is, the VHDL emulation chip 151 is a hardware emulation of some or all of the software instructions found in VMPP 148. In one embodiment, VHDL emulation chip 151 is a programmable read only memory (PROM) that, once burned in accordance with instructions from VMPP 148 and VHDL program 139, is permanently transformed into a new circuitry that performs the functions needed to perform the processes of the present invention.

The hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

A cloud computing environment allows a user workload to be assigned to a virtual machine (VM) somewhere in the computing cloud. This virtual machine provides the software operating system and physical resources such as processing power and memory to support the user's application workload. The present disclosure describes methods for placing virtual machines among physical servers based on workload bids submitted by a plurality of servers in response to a workload bid request received from another one of the servers.

FIG. 5 depicts an exemplary blade chassis that may be utilized in accordance with one or more embodiments of the present invention. The exemplary blade chassis 202 may operate in a “cloud” environment to provide a pool of resources. Blade chassis 202 comprises a plurality of blades 204a-n (where “a-n” indicates an integer number of blades) coupled to a chassis backbone 206. Each blade supports one or more virtual machines (VMs). As known to those skilled in the art of computers, a VM is a software implementation (emulation) of a physical computer. A single hardware computer (blade) can support multiple VMs, each running the same, different, or shared operating systems. In one embodiment, each VM can be specifically tailored and reserved for executing software tasks 1) of a particular type (e.g., database management, graphics, word processing etc.); 2) for a particular user, subscriber, client, group or other entity; 3) at a particular time of day or day of week (e.g., at a permitted time of day or schedule); etc.

As depicted in FIG. 5, blade 204a supports VMs 208a-n (where “a-n” indicates an integer number of VMs), and blade 204n supports VMs 210a-n (wherein “a-n” indicates an integer number of VMs). Blades 204a-n are coupled to a storage device 212 that provides a hypervisor 214, guest operating systems, and applications for users (not shown). Provisioning software from the storage device 212 allocates boot storage within the storage device 212 to contain the maximum number of guest operating systems, and associates applications based on the total amount of storage (such as that found within storage device 212) within the cloud. For example, support of one guest operating system and its associated applications may require 1 GByte of physical memory storage within storage device 212 to store the application, and another 1 GByte of memory space within storage device 212 to execute that application. If the total amount of memory storage within a physical server, such as boot storage device 212, is 64 GB, the provisioning software assumes that the physical server can support 32 virtual machines. This application can be located remotely in the network 216 and transmitted from the network attached storage 217 to the storage device 212 over the network. The global provisioning manager 232 running on the remote management node (Director Server) 230 performs this task. In this embodiment, the computer hardware characteristics are communicated from the VPD 151 to the VMPP 148. The VMPP 148 communicates the computer physical characteristics to the blade chassis provisioning manager 222, to the management interface 220, and to the global provisioning manager 232 running on the remote management node (Director Server) 230.

Note that chassis backbone 206 is also coupled to a network 216, which may be a public network (e.g., the Internet), a private network (e.g., a virtual private network or an actual internal hardware network), etc. Network 216 permits a virtual machine workload 218 to be communicated to a management interface 220 of the blade chassis 202. This virtual machine workload 218 is a software task whose execution, on any of the VMs within the blade chassis 202, is to request and coordinate deployment of workload resources with the management interface 220. The management interface 220 then transmits this workload request to a provisioning manager/management node 222, which is hardware and/or software logic capable of configuring VMs within the blade chassis 202 to execute the requested software task. In essence the virtual machine workload 218 manages the overall provisioning of VMs by communicating with the blade chassis management interface 220 and provisioning management node 222. Then this request is further communicated to the VMPP 148 in the computer system. Note that the blade chassis 202 is an exemplary computer environment in which the presently disclosed methods can operate. The scope of the presently disclosed system should not be limited to a blade chassis, however. That is, the presently disclosed methods can also be used in any computer environment that utilizes some type of workload management or resource provisioning, as described herein. Thus, the terms “blade chassis,” “computer chassis,” and “computer environment” are used interchangeably to describe a computer system that manages multiple computers/blades/servers.

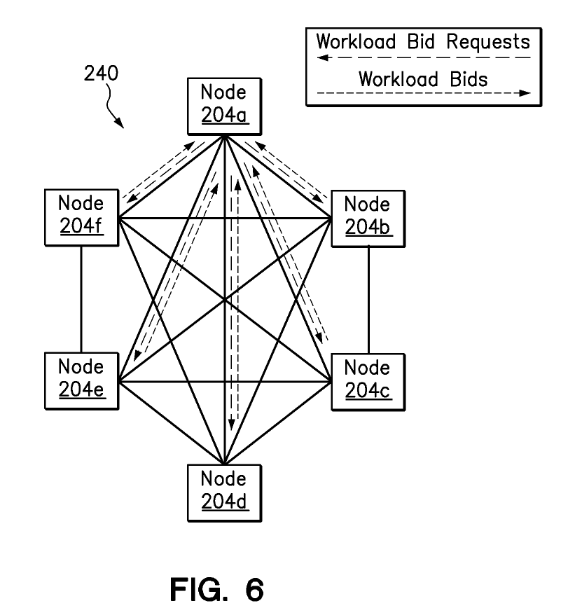

FIG. 6 is a diagram of a first compute node 204a broadcasting instances of a workload bid request to a group of compute nodes 204b-204f that respond to the first compute node with a workload bid. The topology of the network 240 is only one non-limiting example, and it should be recognized that the invention is not limited to any specific network architecture. Furthermore, it is not necessary that every compute node 204b-204f respond with a workload bid, as shown in FIG. 6. Rather, one or more of the compute nodes 204b-204f may decide not to submit a workload bid, for example because the relevant compute node is resource constrained. Still further, the communications illustrated in FIG. 6 are shown as a set out directed communications and directed responses, but network topology or communication protocols may allow a workload bid request to be passed from one compute node to another, and/or allow a workload bid to be passed from one compute node to another so long as it is eventually shared with the first compute node that originated the workload bid request.

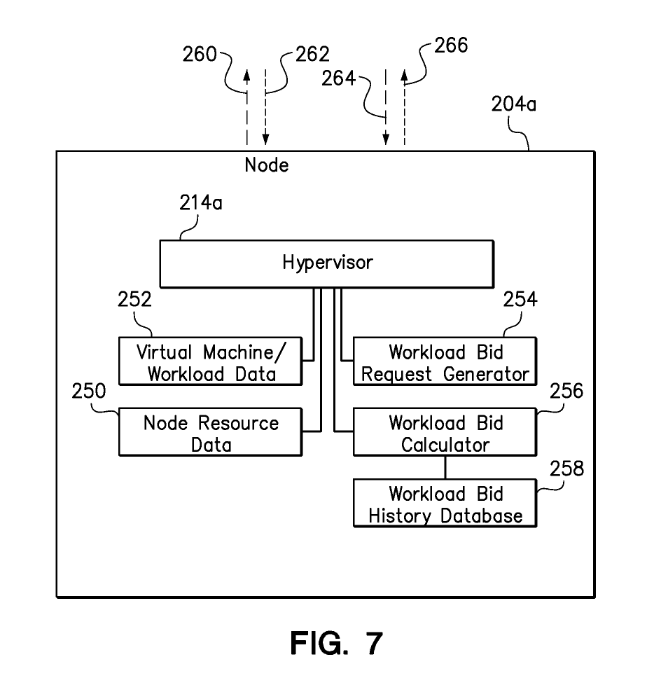

FIG. 7 is a diagram of an individual compute node 204a which is representative of all compute nodes in the system that will participate in the workload bidding. In the embodiment shown, the compute node 204a includes a hypervisor 214a that may be responsible for managing virtual machines on the compute node. The hypervisor 214a has access to node resource data 250 and virtual machine/workload data 252. When the compute node 204a is resource constrained and has a further workload or virtual machine to process, the hypervisor 214a may instruct a workload bid request generator 254 to prepare a workload bid request that includes various workload parameters and/or a cost function. The hypervisor 214a then broadcasts the resulting workload bid request 260 to other compute nodes in the system. One or more of those compute nodes will respond with a workload bid 262 as described herein.

In the present example, workload bid requests may be received by hypervisors in each of the other compute nodes. If the compute node 204a shown in FIG. 7 receives a workload bid request 264, the workload parameters and/or cost function provided within the workload bid request are shared with the workload bid calculator 256. The workload bid calculator 256 uses this information, as well as the node resource data 250 and the virtual machine/workload data 252, to calculate a “cost” of running the workload. This cost is communicated back to the originating compute node in the form of a workload bid 266. The workload bid calculator 256 may periodically calculate a revised workload bid that reflects the current load on the compute node. For example, if the compute node 204a completes an existing workload, then a greater portion of its resources become available and the cost in the subsequently calculated workload bid may decline.

When a workload bid is accepted and the associated workload is dispatched to a particular target compute node, the hypervisor on the target compute node will receive and monitor execution of the workload on the compute node. Furthermore, compute nodes that are not selected as the target compute node will be notified that the workload has been assigned, thereby indicating that the workload bid calculator should no longer generate further workload bids in relation to that workload bid request. Optionally, the compute will be informed of the “cost” in the winning bid, such that the compute node 204a may store the winning cost in association with the workload parameters for a given workload. This data may be stored in a workload bid history database 258 and utilized by the workload bid calculator 256 in preparing subsequent workload bids.

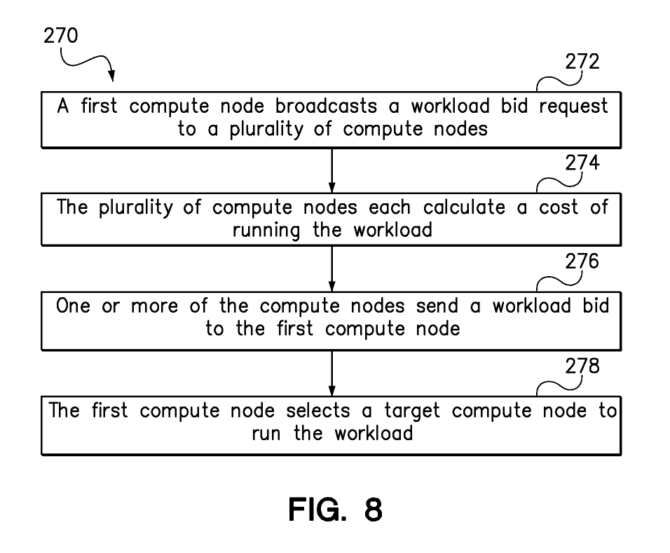

FIG. 8 is a flowchart of a method 270 for workload management in a computer system. In step 272, a first compute node broadcasts a workload bid request to a plurality of compute nodes, wherein the workload bid request includes workload parameters characterizing the workload. In step 274, the plurality of compute nodes each receiving the workload bid request from the first compute node and uses the workload parameters included in the workload bid request to calculate a cost of running the workload. One or more individual compute nodes within the plurality of compute nodes will then send a workload bid to the first compute node in step 276. Each workload bid will include the cost of running the workload on the individual compute node sending the workload bid. Next, in step 278, the first compute node receives each workload bid and using each workload bid to select a target compute node to run the workload. The target compute node may be selected from the one or more individual compute nodes and the first compute node. It should be recognized that this method may be performed for any number of compute nodes and any number of workload bid requests at any given time. Furthermore, a given compute node may generate and broadcast a workload bid request as to a first workload, while also receiving a workload bid request and calculating/responding with a workload bid as to a second workload.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1-9. (canceled)

10. A computer program product including computer usable program code embodied on a computer usable storage medium for managing workload in a computer system, the computer program product comprising:
computer usable program code for a first compute node broadcasting a workload bid request to a plurality of compute nodes, wherein the workload bid request includes workload parameters characterizing the workload;
computer usable program code for the plurality of compute nodes each receiving the workload bid request from the first compute node, wherein each of the plurality of compute nodes uses the workload parameters included in the workload bid request to calculate a cost of running the workload;
computer usable program code for one or more individual compute nodes within the plurality of compute nodes each sending a workload bid to the first compute node, wherein each workload bid includes the cost of running the workload on the individual compute node sending the workload bid; and
computer usable program code for the first compute node receiving each workload bid and using each workload bid to select a target compute node to run the workload, wherein the target compute node is selected from the one or more individual compute nodes and the first compute node.

11. The computer program product of claim 10, wherein the first compute node and the plurality of compute nodes are included in a network.

12. The computer program product of claim 10, further comprising:
computer usable program code for the first compute node selecting to run the workload on the first compute node.

13. The computer program product of claim 10, wherein the workload bid request includes a cost function that the plurality of compute nodes use to calculate the cost of running the workload.

14. The computer program product of claim 13, wherein the cost function includes one or more factors selected from memory available, battery life remaining, time to process, and monetary cost.

15. The computer program product of claim 13, wherein the cost function includes an optimization parameter selected from time, energy use, and monetary cost.

16. The computer program product of claim 10, further comprising:
computer usable program code for the first compute node broadcasting that the workload bid request has been awarded.

17. The computer program product of claim 10, further comprising:
computer usable program code for the first compute node broadcasting the cost included in the workload bid of the target compute node selected to receive the workload.

18. The computer program product of claim 17, further comprising:
computer usable program code for the plurality of compute nodes, other than the target compute node, receiving the cost included in the workload bid of the target compute node and tracking the cost and workload parameters of selected compute node for use in preparing workload bids for subsequent workload bid requests.
